(19) United States
(12) Patent Application Publication
(10) Pub. No.: US 2025/0142006 A1
(43) Pub. Date: May 1, 2025

(54) NON-TRANSITORY COMPUTER-READABLE RECORDING MEDIUM STORING COMPUTER-READABLE INSTRUCTIONS FOR TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventor: Takeshi SHIOTANI, Nagoya (JP)

(21) Appl. No.: 18/923,978

(22) Filed: Oct. 23, 2024

(30) Foreign Application Priority Data
Oct. 27, 2023 (JP) 2023-184723

(51) Int. Cl. H04N 1/00

(52) U.S. Cl. CPC H04N 1/00244; H04N 1/00474

(57) ABSTRACT

A terminal device may receive, from a first server, notification related information including format information. The terminal device may, in a case where the notification related information includes first format information indicating a first display format, display on a display of the terminal device a first notification screen according to the first display format. The first notification screen may include first notification information related to first related information included in the notification related information. The terminal device may, in a case where the notification related information includes second format information indicating a second display format different from the first display format, display on the display a second notification screen according to the second display format. The second notification screen may include second notification information related to second related information included in the notification related information.

### REFERENCE TO RELATED APPLICATION

This application claims priority to Japanese Patent Application No. 2023-184723 filed on Oct. 27, 2023. The entire content of the priority application is incorporated herein by reference.

### BACKGROUND ART

A communication system including an MFP, a terminal device, a notification server, a service providing server, and a service management server is known. The terminal device displays a pull notification screen as a pop-up screen on its display when a filter condition and a timing condition are satisfied.

### SUMMARY

The disclosure herein provides technologies that improve user convenience.

The disclosure herein provides a non-transitory computer-readable recording medium storing computer-readable instructions for a terminal device comprising a processor. The computer-readable instructions, when executed by the processor, may cause the terminal device to: receive, from a first server, notification related information including format information indicating an information display format and related information related to notification information for a target device communicable with the terminal device; in a case where the notification related information includes first format information indicating a first display format, display on a display of the terminal device a first notification screen according to the first display format, wherein the first notification screen includes first notification information related to first related information included in the notification related information; and in a case where the notification related information includes second format information indicating a second display format different from the first display format, display on the display a second notification screen according to the second display format, wherein the second notification screen includes second notification information related to second related information included in the notification related information.

According to the configuration above, the terminal device displays on the display the first notification screen according to the first display format when receiving from the first server the notification related information including the first format information. Also, the terminal device displays on the display the second notification screen according to the second display format when receiving from the first server the notification related information including the second format information. Thus, depending on the notification related information received from the first server, the terminal device can switch the display formats for the notification screens. This improves user convenience.

The terminal device implemented by the above computer-readable instructions and a method for controlling the terminal device are also novel and useful. A communication system including the terminal device, the target device, and the first server is also novel and useful.

### BRIEF DESCRIPTION OF DRAWINGS

FIG. 1 shows a configuration of a communication system.

FIG. 2 shows examples of tables.

FIG. 3 shows examples of tables.

FIG. 4 shows examples of screens displayed on a terminal device in a registration process.

FIG. 5 shows a flowchart of an information screen display process executed by the terminal device.

FIG. 6 shows a flowchart of a first notification process executed by the terminal device.

FIG. 7 shows a flowchart of a notification display process executed by the terminal device.

FIG. 8 shows a flowchart of a second notification process executed by the terminal device.

FIG. 9 shows examples of screens displayed at the terminal device in Case A.

FIG. 10 shows examples of screens displayed at the terminal device in Case B.

FIG. 11 shows examples of screens displayed at the terminal device in Case C.

FIG. 12 shows an example of a fixed-type notification screen according to a modification 7.

FIG. 13 shows an example of a normal-banner notification screen according to a modification 11.

### DESCRIPTION

### Embodiment

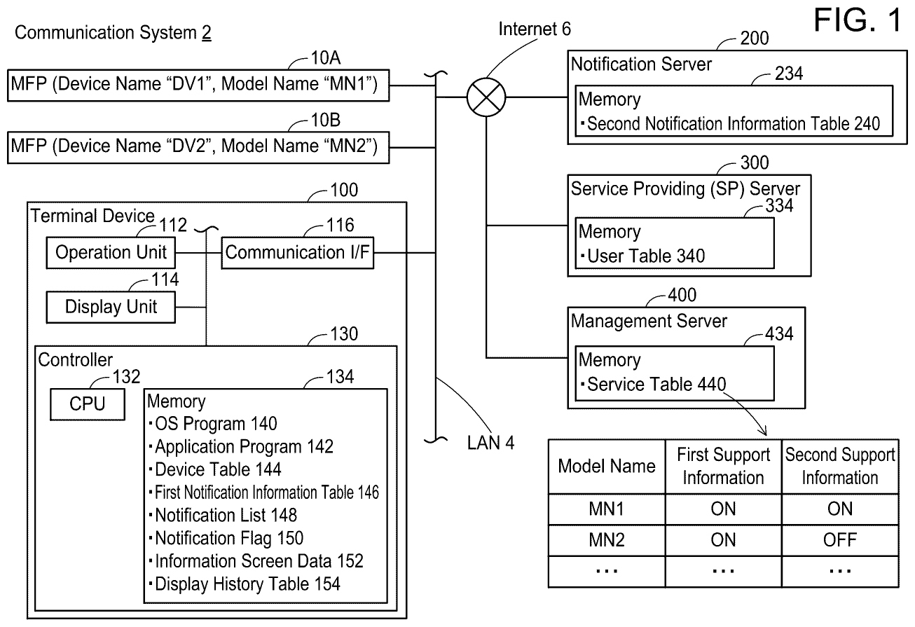

### Configuration of Communication System 2: FIG. 1

As shown in FIG. 1, a communication system 2 comprises a plurality of MFPs including an MFP 10A and an MFP 10B, a terminal device 100, a notification server 200, a service providing server 300, and a management server 400. Hereinafter, the service providing server is abbreviated as “SP server”. The MFPs 10A, 10B and the terminal device 100 are connected to a local area network (LAN) 4. The MFPs 10A, 10B and the terminal device 100 are communicable with each other via the LAN 4. The MFPs 10A, 10B, the terminal device 100, the notification server 200, the SP server 300, and the management server 400 are connected to the internet 6. The MFPs 10A, 10B, the terminal device 100, the notification server 200, the SP server 300, and the management server 400 are communicable with each other via the internet 6.

### Configurations of MFPs 10A, 10B

The MFPs 10A, 10B are peripheral devices (i.e., peripheral devices of PCs, etc.) configured to execute a print function and a scan function. The MFPs 10A, 10B include a print execution unit for realizing a print function and a scan execution unit for realizing a scan function. The print execution unit includes a print engine of an inkjet type, an electrophotographic type, or a thermal type. An inkjet print engine includes a print head that ejects ink droplets. An electrophotographic print engine includes a photosensitive member, an exposure device that emits light to expose the photosensitive member, and the like. A thermal print engine includes a print head that generates heat by a heater. The scan execution unit includes a scanner engine having an image sensor of a charge-coupled device (CCD) image sensor type, a contact image sensor (CIS) type, or the like. The MFP 10A has a device name “DV1” and a model name “MN1”. The MFP 10B has a device name “DV2” and a model name “MN2”. The device names are given to the MFPs 10A, 10B by the administrator of the MFPs. The model names indicate models of the MFPs. The MFPs 10A, 10B were manufactured by the same vendor. Hereinafter, the MFP 10A and the MFP 10B may be collectively termed “MFPs 10”.

### Configuration of Terminal Device 100

The terminal device 100 is a mobile phone (e.g., a smartphone), a PDA, a desktop PC, a laptop PC, a tablet PC, or the like. The terminal device 100 comprises an operation unit 112, a display unit 114, a communication interface 116, and a controller 130. Hereinafter, an interface is abbreviated as “I/F”.

The operation unit 112 is an I/F configured to allow a user to input various information to the terminal device 100 and comprises for example a touch screen, buttons, or both of them. The display unit 114 is a display or a panel configured to display various information. The panel may be or may not be a touch panel. The panel is for example a liquid crystal panel or an organic EL panel. The communication I/F 116 is connected to the LAN 4.

The controller 130 comprises a CPU 132 and a memory 134. The memory 134 comprises a main storage and an auxiliary storage. In an example, the main storage includes a RAM and a cache memory. In an example, the auxiliary storage is a ROM, a flash memory, a solid state drive (SSD), a hard disk drive (HDD), or a combination of them. The auxiliary storage of the memory 134 stores an OS program 140 and an application program 142. Hereinafter, the OS program 140 and the application program 142 are abbreviated as “OS 140” and “app 142”, respectively. The OS 140 controls basic operations of the terminal device 100. In an example, the app 142 causes the MFPs 10 to execute their print functions. The CPU 132 executes various processes according to programs loaded from the auxiliary storage to the main storage.

The auxiliary storage of the memory 134 further stores a device table 144, a first notification information table 146, a notification list 148, a notification flag 150, information screen data 152, and a display history table 154. The notification list 148 is a list of notification screens to be displayed. The notification flag 150 selectively indicates either “ON” indicating that display of a notification screen is permitted or “OFF” indicating that display of a notification screen is prohibited. The information screen data 152 represents a screen that provides information on a subscription service provided by the SP server 300 to the user.

### Configuration of Notification Server 200

The notification server 200 is installed on the internet 6 by a business operator different from the vendor of the MFPs 10. The notification server 200 may be a physical server or a virtual server, a virtual machine, or the like on the cloud. The notification server 200 may be a single server or a collective entity of multiple servers. The notification server 200 may be a server on an intranet or a cloud server on the internet 6. In a modification, the notification server 200 may be installed on the internet 6 by the vendor of the MFPs 10. In another modification, the vendor may not prepare hardware for the notification server 200 by themselves and may use an environment provided by an external cloud computing service. In this case, the vendor may prepare programs (i.e., software) for the notification server 200 and introduce them to the above environment to implement the notification server 200. In this embodiment, the notification server 200 is a physical server, although this is merely an example.

The notification server 200 provides notification related information. The notification related information is related to notification information for the MFPs 10 communicable with the terminal device 100. The notification server 200 sends the notification related information to the terminal device 100 in response to receiving a notification related information request from the terminal device 100. The notification server 200 comprises a memory 234. The memory 234 comprises a main storage and an auxiliary storage. The memory 234 stores a second notification information table 240 in the auxiliary storage.

### Configurations of SP Server 300 and Management Server 400

The SP server 300 and the management server 400 are installed on the internet 6 by the vendor of the MFPs 10. The SP server 300 and the management server 400 each may be a physical server or a virtual server, a virtual machine, or the like on the cloud. The SP server 300 and the management server 400 each may be a single server or a collective entity of multiple servers. The SP server 300 and the management server 400 each may be a server on an intranet or a cloud server on the internet 6. In a modification, the SP server 300 and the management server 400 each may be installed on the internet 6 by a business operator different from the vendor of the MFPs 10. In another modification, the vendor may not prepare hardware for the SP server 300 and the management server 400 by themselves and may use an environment provided by an external cloud computing service. In this case, the vendor may prepare programs (i.e., software) for the SP server 300 and the management server 400 and introduce them to the above environment to implement the SP server 300 and the management server 400. In this embodiment, the SP server 300 and the management server 400 are physical servers, although this is merely an example.

The SP server 300 provides services related to the MFPs 10. The SP server 300 provides a remote print service and a subscription service. The remote print service enables users to send print instructions to the MFPs 10 via the SP server 300 when they are away from home. The subscription service is a flat-rate service that charges a predetermined amount when the number of printed sheets within a predetermined period (e.g., within a month) is equal to or less than the contractual number of sheets (e.g., 1000 sheets) and charges, when the number of printed sheets within the predetermined period is beyond the contractual number of sheets, a total of the flat fee and an amount for the extra sheets beyond the contractual number of sheets. The subscription service includes automatic shipping service that automatically ships new cartridges when remaining amounts of ink in cartridges mounted in the MFPs 10 become equal to or less than a predetermined remaining amount. The SP server 300 comprises a memory 334. The memory 334 stores a user table 340.

The management server 400 manages support information for the remote print service and the subscription service. The management server 400 comprises a memory 434. The memory 434 comprises a main storage and an auxiliary storage. The memory 434 stores a service table 440 in the auxiliary storage. The service table 440 stores model names, first support information, and second support information in association with each other. Each first support information selectively indicates either “ON” indicating that the remote print service is supported and “OFF” indicating that the remote print service is not supported. Each second information selectively indicates either “ON” indicating that the subscription service is supported and “OFF” indicating that the subscription service is not supported.

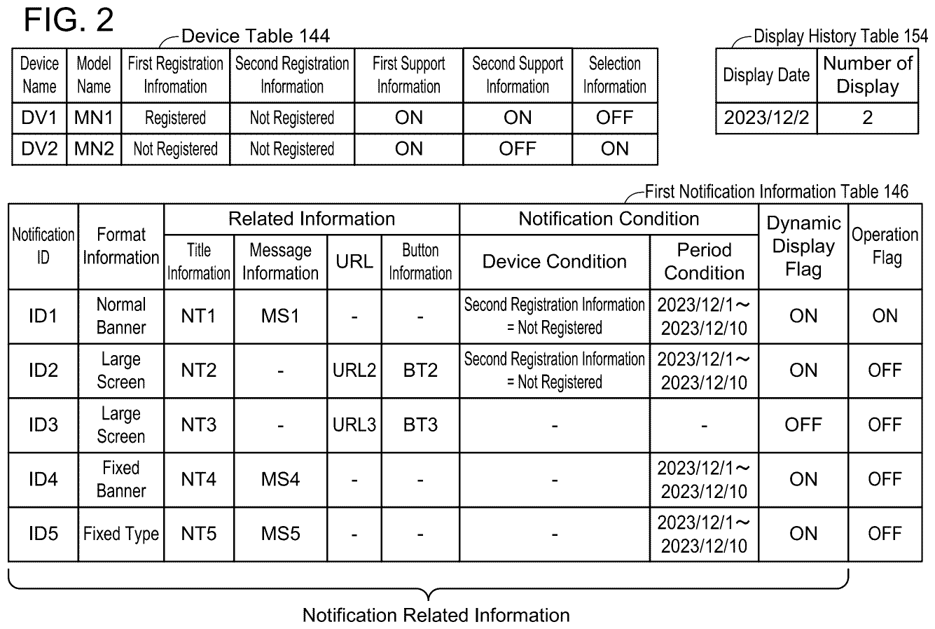

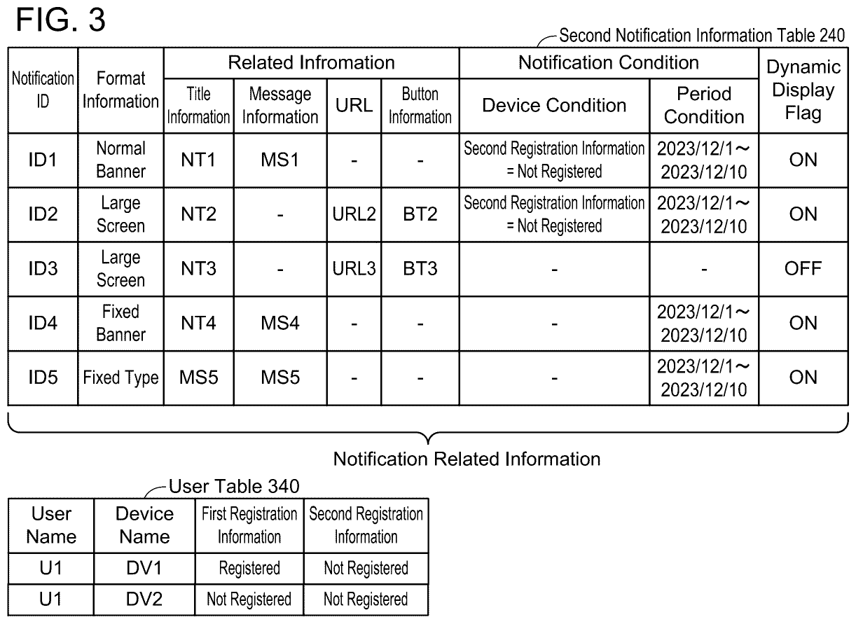

### Tables: FIGS. 2, 3

Referring to FIG. 2, the device table 144, the first notification information table 146, and the display history table 154 in the terminal device 100 are described.

The device table 144 is for management of information related to devices registered in the app 142. The device table 144 stores device names, model names, first registration information, second registration information, first support information, second support information, and selection information in association with each other. Each first registration information selectively indicates either “Registered” indicating that the remote print service is provided to a user of the device associated with the first registration information or “Not Registered” indicating that the remote print service is not provided to the user. Each second registration information selectively indicates either “Registered” indicating that the subscription service is provided to a user of the device associated with the second registration information or “Not Registered” indicating that the subscription service is not provided to the user. Each selection information selectively indicates either “ON” indicating that the device associated with the selection information is a destination of instruction information or “OFF” indicating that the device is not a destination of instruction information. The instruction information is a print instruction, a scan instruction, or the like.

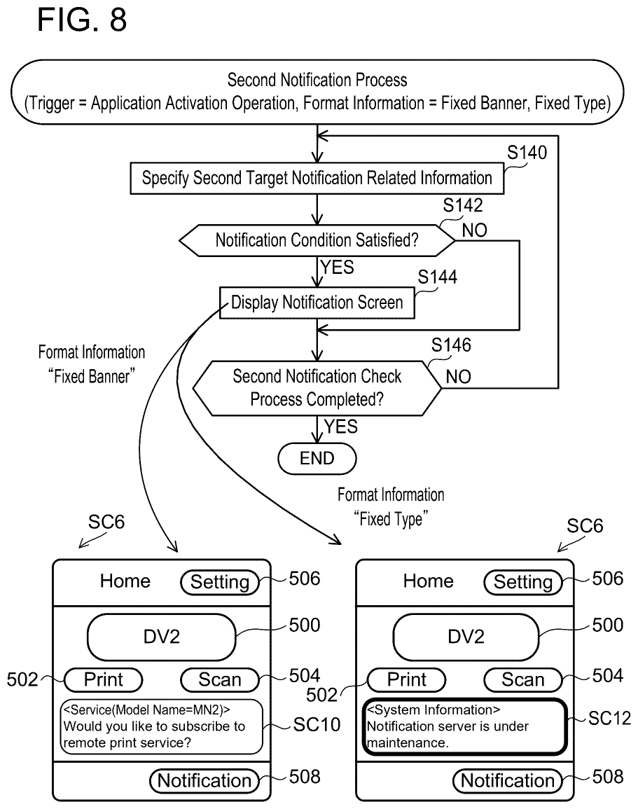

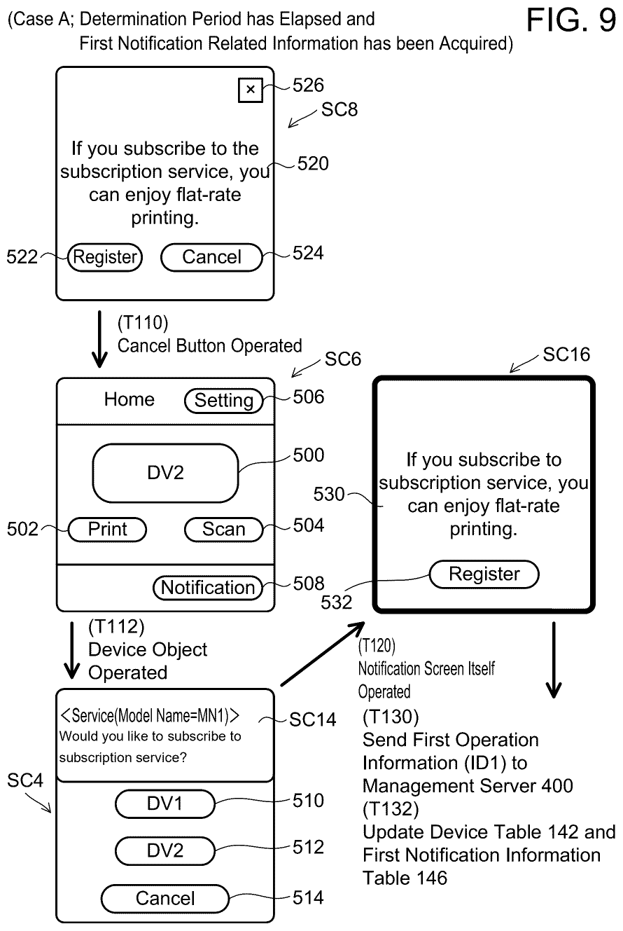

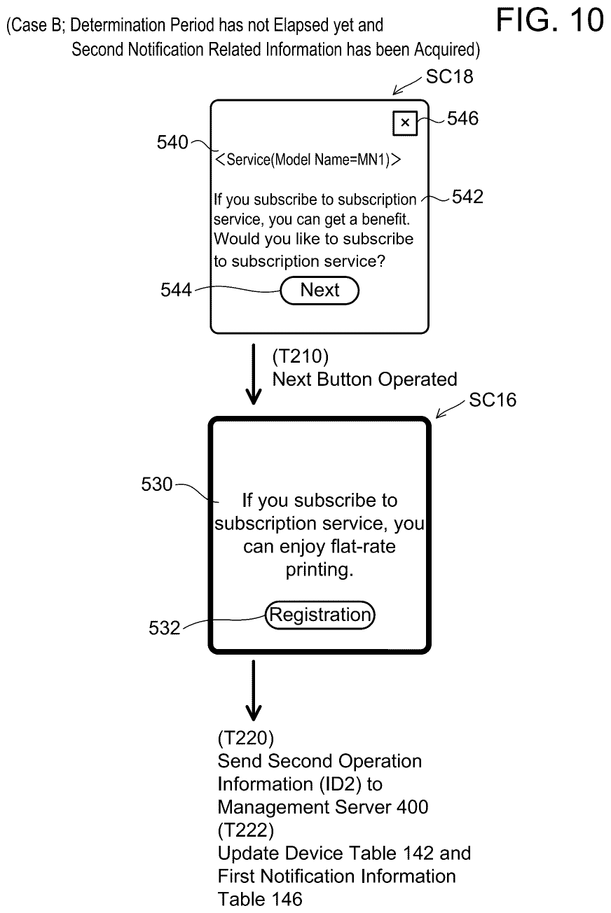

The first notification information table 146 is for management of notification related information received from the notification server 200. The first notification information table 146 stores notification related information and operation flags in association with each other. Each notification related information includes a notification ID for identifying the notification related information, format information indicating a display format of a notification screen, related information, a notification condition, and a dynamic display flag. The display format indicates a size of a screen, a position at which the screen is to be displayed, etc. Each notification related information further includes a model name, although this is not shown. The format information indicates “Normal Banner”, “Large Screen”, “Fixed Banner”, or “Fixed Type”. The format information “Normal Banner” indicates that a banner-format notification screen (e.g., notification screen SC14 in FIG. 9) is to be displayed on the display unit. The notification screen displayed according to the format information “Normal Banner” disappears from the display unit in response to elapse of a notification period (e.g., seven seconds) from when the notification screen started to be displayed. That is, the notification screen displayed according to the format information “Normal Banner” becomes invisible on the display unit in response to the elapse of the notification period from when the notification screen started to be displayed. The format information “Large Screen” indicates that a notification screen larger in size than the banner-format notification screen (e.g., notification screen SC18 in FIG. 10) is to be displayed on the display unit. This notification screen is a so-called modal screen that does not permit operations to other screens unless a button in the notification screen is operated. This notification screen does not disappear from the display unit in response to the elapse of the notification period from when the notification screen started to be displayed. The format information “Fixed Banner” indicates that a banner-format notification screen (e.g., notification screen SC10 in FIG. 8) is to be displayed on the display unit. This notification screen does not disappear from the display unit 114 in response to the elapse of the notification period from when the notification screen started to be displayed. The format information “Fixed Type” indicates that a fixed-type notification screen (e.g., notification screen SC12 in FIG. 8) is to be displayed on the display unit. Here, “fixed-type” means that the notification screen does not disappear from the display unit 114 even when an operation to select the notification screen itself is received from the user.

The related information is related to notification information for the MFPs communicable with the terminal device 100. In case of the format information being “Normal Banner”, “Fixed Banner”, or “Fixed Type”, the related information includes title information and message information. The title information indicates a title (i.e., a character string) to be displayed in a notification screen. The message information indicates a message (i.e., a character string) to be displayed in a notification screen. In case of the format information being “Large Screen”, the related information includes title information, a URL, and button information. The URL is for acquisition of character information, image information, etc. to be displayed in a notification screen. The button information indicates a character string to be displayed on a button in a notification screen.

The notification condition includes a device condition and a period condition. The device condition is information indicating a device-related condition. In an example, the device condition indicates “Second Registration Information=Not Registered”. The period condition is information indicating a period during which a notification screen is to be displayed.

The dynamic display flag selectively indicates either “ON” indicating that when the notification condition is satisfied, display of a notification screen is permitted even without an operation to display the notification screen (termed “notification screen display operation” hereinafter) from the user or “OFF” indicating that display of a notification screen is prohibited without the notification screen display operation from the user.

The operation flag selectively indicates either “ON” indicating that a user operation to a notification screen has been received or “OFF” indicating that a user operation to a notification screen has not been received.

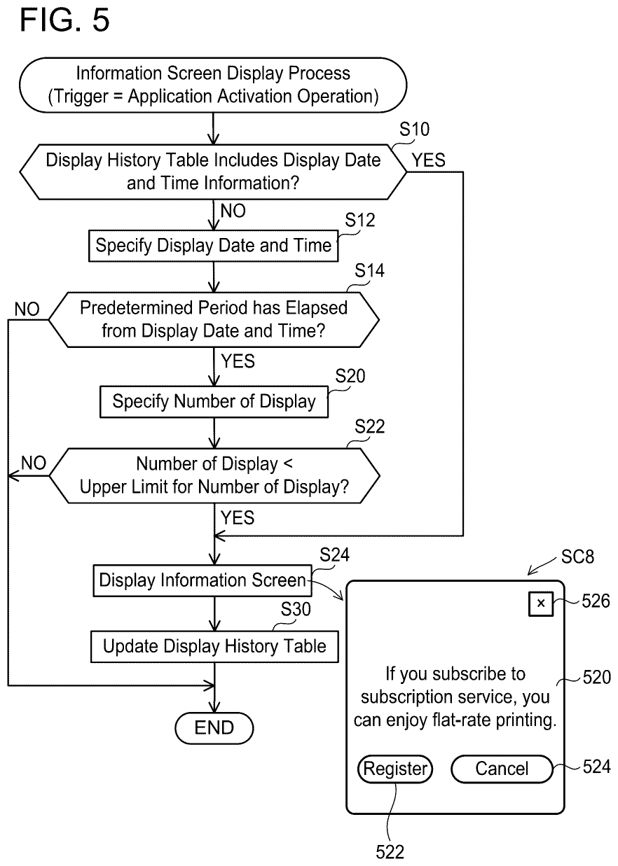

The display history table 154 is for display history management of an information screen SC8 (see FIG. 5) represented by the information screen data 152 in the memory 134. The display history table 154 stores display date information indicating the latest date on which the information screen SC8 was displayed and display number information indicating how many times the information screen SC8 has been displayed (termed “display number” hereinafter).

Referring to FIG. 3, the second notification table 240 in the notification server 200 and the user table 340 in the SP server 300 are described.

The second notification information table 240 is for management of notification related information. The second notification information table 240 stores one or more notification related information. Each information in the second notification information table 240 is registered in the notification server 200 by the vendor of the MFPs 10 asking the business operator that installed the notification server 200 to register notification related information. That is, the notification conditions included in the one or more notification related information are determined by the notification server 200.

The user table 340 in the SP server 300 is for management of user-related information. The user table 340 stores user names for identifying users, device names, first registration information, and second registration information in association with each other. The user names are registered upon subscription to the remote print service or the subscription service.

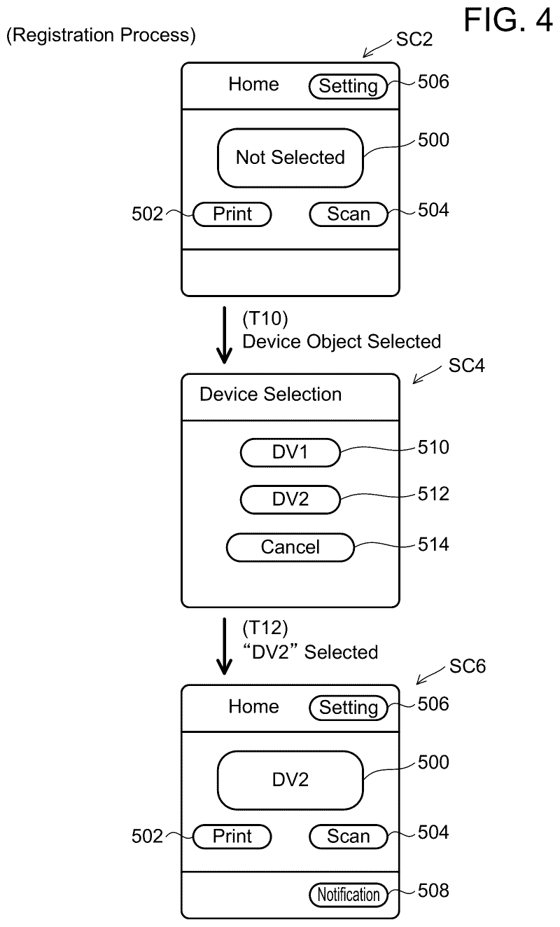

### Registration Process: FIG. 4

Referring to FIG. 4, a process to register a device in the app 142 is described. In the following description, all communications between the terminal device 100 and the other devices (the MFPs 10, the notification server 200, the SP server 300, and the management server 400) are via the communication I/F 116 of the terminal 100. Therefore, a phrase “via the communication I/F 116” is omitted in the following description. Further, the app 142 accesses hardware such as the display unit 114, the memory 134, the communication I/F 116, etc. via the OS 140 to execute various processes. In the following description, the app 142 executing the processes via the OS 140 may be omitted.

First, the user of the terminal device 100 performs an operation to activate the app 142 (termed “app activation operation” hereinafter) to the terminal device 100. In response, the app 142 in the terminal device 100 displays a home screen SC2 on the display unit 114. The home screen SC2 includes a device object 500, a print button 502, a scan button 504, and a setting button 506. The device object 500 shows information related to a device to which instruction information is to be sent. If two or more devices have already been registered in the app 142, the device object 500 shows information related to one of the two or more devices. If no devices have been registered in the app 142, the device object 500 shows a character string “Not Selected”. The setting button 506 is for displaying a setting screen (not shown) on which the user can change the setting of the notification flag 150.

In T10, the user performs an operation to the device object 500 in the home screen SC2. In response, the app 142 executes a search to search for devices within the LAN 4 and displays a device selection screen SC4 on the display unit 114. In the search, the app 142 sends a search signal to the LAN 4 to search for devices within the LAN 4 and receives response signals, each including a device name and a model name, from devices within the LAN 4 (the two MFPs 10A, 10B in this embodiment). The app 142 displays the device selection screen SC4 on the display unit 114 by using the received response signals. The device selection screen SC4 includes device buttons 510, 512 corresponding to the received response signals and a cancel button 514. The device buttons 510, 512 each are for selection of a device to be registered in the app 142. The device buttons 510 and 512 correspond to the MFP 10A and the MFP 10B, respectively.

In T12, the user performs an operation to the device button 512 in the device selection screen SC4. In response, the app 142 stores the device name “DV2” and the model name “MN2” associated with the device button 512 in the device table 144. The app 142 further stores first registration information “Not Registered”, second registration information “Not Registered”, and selection information “ON” in the device table 144. The app 142 then sends a support information request including the model name “MN2” to the management server 400 and receives support information including first support information “ON” and second support information “OFF” from the management server 400. Then, the app 142 stores the first support information “ON” and the second support information “OFF” in the device table 144. In this way, the MFP 10B is registered in the app 142. The app 142 then displays a home screen SC6 on the display unit 114. The home screen SC6 is the same as the home screen SC2 except that the device object 500 shows the device name “DV2” and a notification button 508 is included in the home screen SC6. The notification button 508 is for displaying a list screen including a list of information in the first notification information table 146. In response to receiving an operation on the print button 502 or the scan button 504 in the home screen SC6 from the user, the terminal device 100 sends instruction information to the MFP 10B. That is, the home screen SC6 also serves as a function selection screen for selecting a function to be executed by the MFP 10B.

### Information Screen Display Process: FIG. 5

Referring to FIG. 5, an information screen display process executed by the app 142 of the terminal device 100 is described. The app 142 starts the process shown in FIG. 5 in response to receiving the app activation operation. The app 142 executes the information screen display process only when the second registration information “Not Registered” is associated with the second support information “ON” in the device table 144.

In S10, the app 142 determines whether the display history table 154 includes display date information. When the display history table 154 includes no display date information (YES in S10), the app 142 proceeds to S24, whereas when the display history table 154 includes display date information (NO in S10), the app 142 proceeds to S12.

In S12, the app 142 specifies the display date indicated by the display date information in the display history table 154. In S14, the app 142 determines whether a predetermined period has elapsed from the specified display date. The predetermined period may be stored in advance in the memory 134 or determined based on operation states of the MFPs 10. When determining that the predetermined period has not yet elapsed from the specified display date (NO in S14), the app 142 terminates the process shown in FIG. 5, whereas when determining that the predetermined period has elapsed from the specified display date (YES in S14), the app 142 proceeds to S20.

In S20, the app 142 specifies the display number indicated by the display number information in the display history table 154. In S22, the app 142 determines whether the specified display number is less than an upper limit. The upper limit may be stored in advance in the memory 134 or determined based on operation states of the MFPs 10. When the specified display number is equal to the upper limit (NO in S22), the app 142 terminates the process shown in FIG. 5, whereas when the specified display number is less than the upper limit (YES in S22), the app 142 proceeds to S24.

In S24, the app 142 displays on the display unit 114 the information screen SC8 represented by the information screen data 152 in the memory 134. The information screen SC8 includes an information message 520, a register button 522, a cancel button 524, and a close button 526. The information message 520 introduces the subscription service and prompts the user to subscribe to the subscription service. In an example, the information message 520 says “If you subscribe to the subscription service, you can enjoy flat-rate printing”. The register button 522 is for accessing a registration page for the subscription service.

In S30, the app 142 updates the display history table 154. Specifically, the app 142 stores the current date as the display date information and increments the display number. When S30 is completed, the app 142 terminates the process shown in FIG. 5. When the app 142 terminates the process shown in FIG. 5 in response to NO in S14 or NO in S22 or when an operation is performed to the cancel button 524 or the close button 526 in the information screen SC8, the app 142 displays a home screen on the display unit 114.

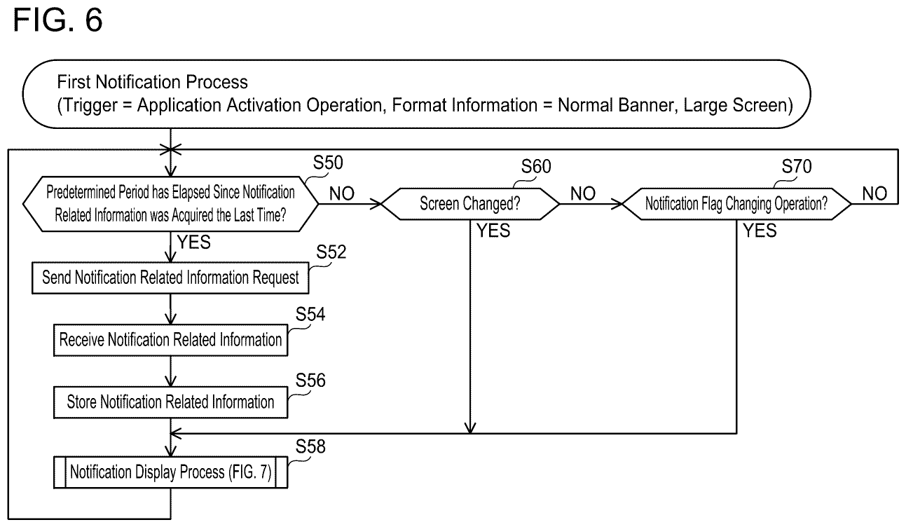

### First Notification Process: FIG. 6

Referring to FIG. 6, a first notification process executed by the app 142 in the terminal device 100 is described. The app 142 starts the process shown in FIG. 6 in response to receiving the app activation operation. When a screen display information process is executed after the app activation operation was received, the app 142 executes the first notification process after the screen display information process has been terminated.

In S50, the app 142 monitors whether a predetermined period (e.g., 24 hours) has elapsed from the last time notification related information was received from the notification server 200. When the predetermined period has elapsed from the last time notification related information was received from the notification server 200, the app 142 determines YES in S50 and proceeds to S52.

In S52, the app 142 sends a notification related information request to the notification server 200. The notification related information request is a signal for requesting notification related information to be sent. The notification related information request includes one or more model names stored in the device table 144. In this case, the notification server 200 sends notification related information corresponding to the one or more model names included in the notification related information request to the terminal device 100.

In S54, the app 142 receives notification related information from the notification server 200.

In S56, the app 142 stores the received notification related information in association with an operation flag “OFF” in the first notification information table 146.

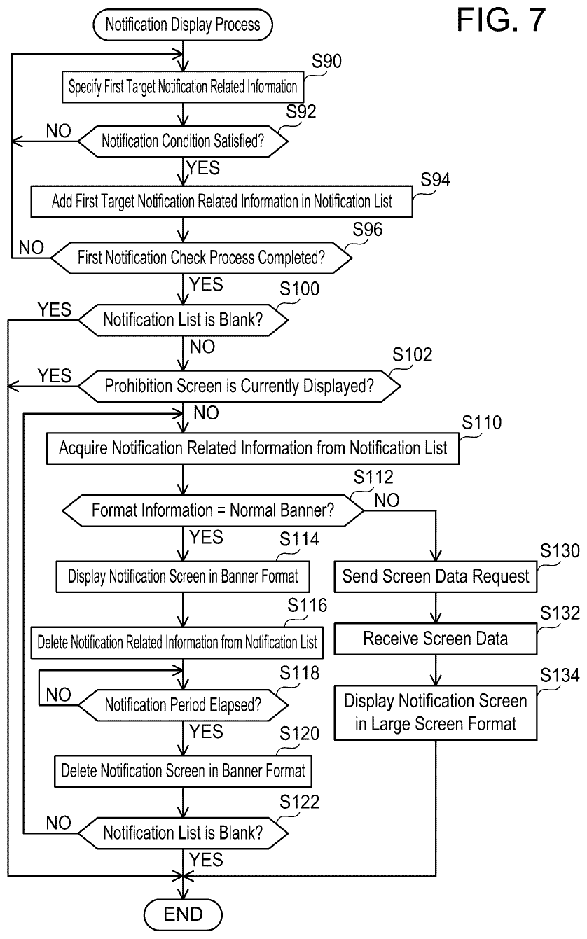

In S58, the app 142 executes a notification display process (see FIG. 7). The notification display process is for displaying a notification screen corresponding to notification related information including the format information “Normal Banner” or “Large Screen”. When S58 is completed, the app 142 returns to S50.

In parallel with the monitoring in S50, the app 142 further monitors in S60 whether a screen on the display unit 114 has changed. When the screen on the display unit 114 has changed, the app 142 determines YES in S60 and proceeds to S58.

In parallel with the monitoring in S50 and the monitoring in S60, the app 142 further monitors in S70 whether an operation to change the notification flag 150 to “ON” (which may be termed “notification flag changing operation” hereinafter) is received. When the notification flag changing operation is received, the app 142 determines YES in S70 and proceeds to S58.

### Notification Display Process: FIG. 7

Referring to FIG. 7, the notification display process executed in S58 in FIG. 6 is described. In S90, the app 142 specifies, in the first notification information table 146, one notification related information as first target notification related information. This notification related information includes the format information “Normal Banner” or “Large Screen” and the dynamic display flag “ON”, and is associated with the operation flag “OFF” in the first notification information table 146.

In S92, the app 142 determines whether the notification condition in the first target notification related information is satisfied. When the notification condition is satisfied (YES in S92), the app 142 proceeds to S94, whereas when the notification condition is not satisfied (NO in S92), the app 142 proceeds to S96. In an example, the first target notification related information may include a device condition “Second Registration Information=Not Registered” and a period condition “2023 Dec. 1 ˜2023 Dec. 10”. In this case, the app 142 determines YES in S92 when the device table 144 includes the second registration information “Not Registered” and today is within the period indicated by the period condition, whereas the app 142 determines NO in S92 when the device table 144 does not include the second registration information “Not Registered” or when today is not included in the period.

In S94, the app 142 adds the first target notification related information to the notification list 148.

In S96, the app 142 determines whether the sequence from S90 to S94 (which may be termed “first notification check process” hereinafter) has been executed to all of notification related information that include the format information “Normal Banner” or “Large Screen” and the dynamic display flag “ON” and are associated with the operation flag “OFF” in the first notification information table 146. When determining that the first notification check process has been executed to all of the notification related information (YES in S96), the app 142 proceeds to S100, whereas when determining that the first notification check process has not yet been executed to one or more of the notification related information (NO in S96), the app 142 returns to S90.

In S100, the app 142 determines whether the notification list 148 is blank. When the notification list 148 is blank (YES in S100), the app 142 terminates the process shown in FIG. 7, whereas when the notification list 148 is not blank (NO in S100), the app 142 proceeds to S102.

In S102, the app 142 determines whether a prohibition screen is being displayed. Prohibition screens prohibit display of notification screens. In this embodiment, the information screen SC8 (see FIG. 5), screens related to print instruction (e.g., a print preview screen, a print setting screen, a print-in-progress screen), and screens related to scan instruction (e.g., a scan setting screen, a scan-in-progress screen) are prohibition screens. When a prohibition screen is being displayed on the display unit 114 (YES in S102), the app 142 terminates the process shown in FIG. 7, whereas when a prohibition screen is not being displayed on the display unit 114 (NO in S102), the app 142 proceeds to S110.

In S110, the app 142 acquires one notification related information from the notification list 148.

In S112, the app 142 determines whether the format information included in the acquired notification related information indicates “Normal Banner”. When the format information indicates “Normal Banner” (YES in S112), the app 142 proceeds to S114, whereas when the format information indicates “Large Screen” (NO in S112), the app 142 proceeds to S130.

In S114, the app 142 displays a banner-format notification screen on the display unit 114 by using the notification related information acquired in S110. Specifically, the app 142 uses the title information and the message information in the notification related information to display the notification screen on the display unit 114. As shown in FIG. 9, a banner-format notification screen SC14 is displayed as a pop-up covering an upper portion of a currently displayed screen on the display unit 114.

In S116 of FIG. 7, the app 142 deletes the notification related information corresponding the acquired notification related information from the notification list 148.

In S118, the app 142 monitors whether a period that has elapsed from when the banner-format notification screen started to be displayed on the display unit 114 exceeds the notification period (e.g., seven seconds). When the period elapsed exceeds the notification period, the app 142 determines YES in S118 and proceeds to S120.

In S120, the app 142 stop displaying the banner-format notification screen on the display unit 114.

S122 is the same as S100. When determining YES in S122, the app 142 terminates the process shown in FIG. 7, whereas when determining NO in S122, the app 142 returns to S110.

After determining NO in S112, the app 142 sends a screen data request to the notification server 200 in S130. The screen data request includes the URL included in the notification related information acquired in S110.

In S132, the app 142 receives, from the notification server 200, screen data corresponding to the URL sent in S130.

In S134, the app 142 displays a large-screen-format notification screen by using the notification related information acquired in S110 and the screen data received in S132. The large-screen-format notification screen is displayed on the display unit 114 covering almost the entirety of a currently displayed screen. When S134 is completed, the app 142 terminates the process shown in FIG. 7. ps Second Notification Process: FIG. 8

Referring to FIG. 8, a second notification process executed by the app 142 in the terminal device 100 is described. The app 142 starts the process shown in FIG. 8 in response to receiving the app activation operation. When the screen display information process is executed after the app activation operation was received, the app 142 executes the second notification process after the screen display information process has been terminated. The app 142 executes the second notification process when a prohibition screen is not displayed on the display unit 114.

In S140, the app 142 specifies one notification related information that includes the format information “Fixed Banner” or “Fixed Type” in the first notification information table 146 as second target notification related information.

In S142, the app 142 determines whether the notification condition in the second target notification related information is satisfied. When the notification condition is satisfied (YES in S142), the app 142 proceeds to S144, whereas when the notification condition is not satisfied (NO in S142), the app 142 proceeds to S146.

In S144, the app 142 displays a notification screen on the display unit 114 by using the second target notification related information.

Here, a case is described where a notification screen SC10 corresponding the format information “Fixed Banner” is to be displayed while the home screen SC6 is being displayed on the display unit 114. The fixed-banner-format notification screen SC10 is displayed over the home screen SC6. The fixed-banner-format notification screen SC10 is displayed over a blank area of the home screen SC6. The notification screen SC10 includes the title information and the message information included in the second target notification related information. In an example, the title information indicates “Service (Model Name=MN2)”, and the message indicated by the message information says “Would you like to subscribe to the remote print service?”. When an operation is performed to the fixed-banner-format notification screen SC10 itself, the app 142 sends operation information including the notification ID included in the second target notification related information to the management server 400, and a screen for subscription to the remote print service is displayed on the display unit 114.

Here, another case is described where a notification screen SC12 corresponding the format information “Fixed Type” is to be displayed while the home screen SC6 is being displayed on the display unit 114. The fixed-type notification screen SC12 is displayed over the home screen SC6. The fixed-type notification screen SC12 is displayed over the blank area of the home screen SC6. The fixed-type notification screen SC12 is displayed in a bolder manner compared to the fixed-banner-format notification screen SC10. In this embodiment, the fixed-type notification screen SC12 is enclosed by a bold-line frame. The fixed-type notification screen SC12 includes the title information and the message information included in the second target notification related information. In an example, the title information indicates “System Information”, and the message information indicates a message saying “The notification server is under maintenance”. When an operation is performed to the fixed-type notification screen SC12 itself, the app 142 sends operation information including the notification ID included in the second target notification related information to the maintenance server 400. According to the above, the user is able to know that access to the notification server 200 is impossible because the notification server 200 is under maintenance. Thus, the user is able to know that acquisition of new notification related information is impossible.

In S146, the app 142 determines whether the sequence from S140 to S144 (which may be termed “second notification check process” hereinafter) has been executed to all of notification related information that include the format information “Fixed Banner” or “Fixed Type” in the first notification information table 146. When determining that the second notification check process has been executed to all of the notification related information (YES in S146), the app 142 terminates the process shown in FIG. 8, whereas when determining that the second notification check process has not yet been executed to one or more of the notification related information (NO in S146), the app 142 returns to S140.

### Specific Cases: FIGS. 9 to 11

Referring to FIGS. 9 to 11, screens displayed in specific cases, which can be realized by the communication system 2 according to this embodiment, are described.

### Case A: FIG. 9

Referring to FIG. 9, Case A is described. In the initial state of Case A, the device name “DV1”, the model name “MN1”, the first registration information “OFF”, the second registration information “OFF”, the first support information “ON”, the second support information “ON”, and the selection information “OFF” are stored in association with each other in the device table 144, and the device name “DV2”, the model name “MN2”, the first registration information “OFF”, the second registration information “OFF”, the first support information “ON”, the second support information “OFF”, and the selection information “ON” are also stored in association each other in the device table 144. In the display history table 154, a display date “2023 Nov. 20” and a display number “2” are stored in association with each other. In the second notification information table 240 in the notification server 200, first notification information including a notification ID “ID1”, the format information “Normal Banner”, title information NT1, message information MS1, a device condition “Second Registration Information=Not Registered”, a period condition “2023 Dec. 1 ˜2023 Dec. 10”, and the dynamic display flag “ON” is stored. The date on which Case A occurs is “2023 Dec. 3”.

First, the user performs the app activation operation to the terminal device 100. In response, the app 142 in the terminal device 100 starts the information screen display process (see FIG. 5). The app 142 determines that the display history table 154 includes display date information (NO in S10), specifies the display date “2023 Nov. 20” in the display history table 154 (S12), and determines that the predetermined period has elapsed from the display date (YES in S14). The app 142 further specifies the display number “2” in the display history table 154 (S20) and determines that the display number “2” is less than the upper limit (e.g., “5”) (YES in S22). In this case, the app 142 displays the information screen SC8 on the display unit 114.

Also, the app 142 starts the first notification process (see FIG. 6). The app 142 determines that the predetermined period has elapsed from the last time notification related information was received from the notification server 200 (YES in S50), sends a notification related information request to the notification server 200 (S52), and receives the first notification related information from the notification server 200 (S54). The app 142 then stores the first notification related information in association with the operation flag “OFF” in the first notification information table 146 (S56). The app 142 then specifies the first notification related information, which includes the format information “Normal Banner” and is associated with the operation flag “OFF” in the first notification information table 146, as first target notification related information (S90 in FIG. 7). Then, the app 142 determines that the notification condition in the first notification related information is satisfied (YES in S92), adds the first notification related information to the notification list 148 (S94), and determines that the first notification check process has been executed to all of notification related information that include the format information “Normal Banner” or “Large Screen” and the dynamic display flag “ON”, and are associated with the operation flag “OFF” (YES in S96). The app 142 then determines that the notification list 148 is not blank (NO in S100) and determines that a prohibition screen is being displayed (YES in S102). In this case, the app 142 does not display a notification screen.

In T110, the user performs an operation to the cancel button 524 in the information screen SC8. In response, the app 142 displays the home screen SC6 on the display unit 114 instead of the information screen SC8.

In T112, the user performs an operation to the device object 500 in the home screen SC6. In response, the app 142 displays the device selection screen SC4 on the display unit 114 instead of the home screen SC6. In this case, the app 142 determines that the screen on the display unit 114 has changed (YES in S60). The app 142 specifies the first notification related information as the first target notification related information (S90 in FIG. 7), determines that the notification condition is satisfied (YES in S92), adds the first notification related information to the notification list 148 (S94), and determines that the first notification check process has been executed (YES in S96). The app 142 then determines that the notification list 148 is not blank (NO in S100) and determines that a prohibition screen is not being displayed (NO in S102). Then, the app 142 acquires the first notification related information from the notification list 148 (S110) and determines that the format information included in the first notification related information indicates “Normal Banner” (YES in S112). In this case, the app 142 displays the banner-format notification screen SC14 on the display unit 114 by using the first notification related information. The banner-format notification screen SC14 is displayed over the device selection screen SC4. In Case A, the banner-format notification screen SC14 includes a title “Service (Model MN1)” and a message “Would you like to subscribe to the subscription service?”. While the banner-format notification screen SC14 is being displayed, a user's operation to the device selection screen SC4 is enabled. That is, when an operation is performed to a button in the device selection screen SC4, the app 142 executes a process corresponding to that button.

In T120, the user performs an operation to the banner-format notification screen SC14 itself (e.g., taps the notification screen SC14). In response, the app 142 supplies a URL corresponding to a subscription service registration screen SC16 to the OS 140. The OS 140 accesses this URL and displays the subscription service registration screen SC16 on the display unit 114. The subscription service registration screen SC16 includes a message 530 related to the subscription service and a register button 532. In an example, the message 530 says “If you subscribe to the subscription service, you can enjoy flat-rate printing”.

In T130, the app 142 sends first operation information including the notification ID “ID1” included in the first notification related information to the management server 400. The first operation information indicates that the operation to the banner-format notification screen itself was performed by the user. In T132, the app 142 updates the device table 144 and the first notification information table 146. Specifically, the app 142 changes the selection information associated with the device name “DV2” to “OFF” and changes the selection information associated with the device name “DV1” to “ON” in the device table 144. As a result, in the home screen to be displayed thereafter, the device object will show the device name “DV1”. Further, the app 142 changes the operation flag associated with the first notification related information to “ON” in the first notification information table 146.

### Advantageous Effects in Case A

As described, in the case where the selection information associated with the device name “DV1” indicates “OFF”, the selection information associated with the device name “DV2” indicates “ON”, and the operation to the banner-format notification screen SC14 itself is received, the terminal device 100 changes the selection information associated with the device name “DV1” to “ON” and changes the selection information associated with the device name “DV2” to “OFF”. In the case where information related to the device name “DV1” is shown on the notification screen SC14, the user is highly likely to use the MFP 10A having the device name “DV1” thereafter. Thus, changing the selection information such that the MFP 10A can be selected as a destination of instruction information improves the user convenience.

### Case B: FIG. 10

Referring to FIG. 10, Case B is described. In the initial state of Case B, the state of the device table 144 is the same as that of the device table 144 in the initial state of Case A. In the display history table 154, a display date “2023 Nov. 30” and a display number “2” are stored in association with each other. In the second notification information table 240 in the notification server 200, second notification related information including a notification ID “ID2”, the format information “Large Screen”, title information NT2, a URL 2, button information BT2, a device condition “Second Registration Information=Not Registered”, a period condition “2023 Dec. 1 ˜2023 Dec. 10”, and the dynamic display flag “ON” is stored. The date on which Case B occurs is “2023 Dec. 3”.

First, the user performs the app activation operation to the terminal device 100. In response, the app 142 in the terminal device 100 starts the information screen display process (see FIG. 5). The app 142 determines that the display history table 154 includes a display date (NO in S10), specifies the display date “2023 Nov. 30” in the display history table 154 (S12), and determines that the predetermined period has not elapsed from the display date (NO in S14). In this case, the app 142 does not display the information screen SC8 on the display unit 114. The app 142 then displays the home screen SC6 on the display unit 114.

Then, the app 142 starts the first notification process (see FIG. 6). The app 142 determines that the predetermined period has elapsed from the last time notification related information was received from the notification server 200 (YES in S50), sends a notification related information request to the notification server 200 (S52), and receives the second notification related information from the notification server 200 (S54). Then, the app 142 stores the second notification related information in association with the operation flag “OFF” in the first notification information table 146 (S56).

The app 142 then specifies the second notification related information, which includes the format information “Large Screen” and is associated with the operation flag “OFF” in the first notification information table 146, as second target notification related information (S90 in FIG. 7). Then, the app 142 determines that the notification condition included in the second notification related information is satisfied (YES in S92) and adds the second notification related information to the notification list 148 (S94). After this, the app 142 executes the sequence from S96 to S102 in the same manner as Case A. The app 142 then acquires the second notification related information from the notification list 148 (S110) and determines that the format information included in the second notification related information does not indicate “Normal Banner” (NO in S112). In this case, the app 142 sends the notification server 200 a screen data request including the URL 2 included in the second notification related information as a destination (S130) and receives screen data corresponding to the URL 2 from the notification server 200 (S132). The app 142 then displays a large-screen-format notification screen SC18 on the display unit 114 by using the title information NT2 and the button information BT2 included in the second notification related information and the received screen data (S134). The large-screen-format notification screen SC18 is displayed over the home screen SC6 covering almost the entirety of the home screen SC6. The large-screen-format notification screen SC18 includes a title 540, a message 542, a next button 544, and a close button 546. In an example, the title 540 indicates “Service (Model MN1)”. In an example, the message 542 says “If you subscribe to the subscription service, you can get a benefit. Would you like to subscribe to the subscription service?”. The character string “Next” on the next button 544 is information indicated by the button information BT2. While the large-screen-format notification screen SC18 is being displayed, a user's operation to the home screen SC6 is disabled. That is, the user cannot perform an operation to the home screen SC6 unless the large-screen-format notification screen SC18 is made invisible by the user performing an operation to the large-screen-format notification screen SC18. The large-screen-format notification screen may further include image information in addition to character strings such as a message.

In T210, the user performs an operation to the next button 544 in the large-screen-format notification screen SC18. In response, the app 142 supplies the URL corresponding to the subscription service registration screen SC16 to the OS 140. The OS 140 accesses this URL to display the subscription service registration screen SC16 on the display unit 114.

In T220, the app 142 sends second operation information including the notification ID “ID2” in the second notification related information to the management server 400. The second operation information indicates that the operation was performed to the button in the large-screen-format notification screen by the user. In T222, the app 142 updates the device table 144 and the first notification information table 146. Specifically, the app 142 changes the selection information associated with the device name “DV2” to “OFF” and changes the selection information associated with the device name “DV1” to “ON” in the device table 144. Further, the app 142 changes the operation flag associated with the second notification related information to “ON” in the first notification information table 146. When the user performs an operation to the close button 546 in the large-screen-format notification screen SC18, the app 142 stop displaying the large-screen-format notification screen SC18 over the home screen SC6. This allows the user to perform an operation to the home screen SC6. In this case, the app 142 does not execute T220 nor T222.

### Advantageous Effects in Cases A, B

As shown by Case A in FIG. 9, in the case where an operation to the banner-format notification screen SC14 itself is received, the terminal device 100 sends the first operation information to the management server 400. As shown by Case B in FIG. 10, in the case where an operation to the next button 544 in the large-screen-format notification screen SC18 is received, the terminal device 100 sends the second operation information to the management server 400. According to this configuration, the administrator of the management server 400 is able to know notification information useful to the user by analyzing the operation information received from the terminal device 100.

As shown by Case B in FIG. 10, in the case where the selection information associated with the device name “DV1” indicates “OFF”, the selection information associated with the device name “DV2” indicates “ON”, and an operation to the next button 544 in the large-screen-format notification screen SC18 is received, the terminal device 100 changes the selection information associated with the device name “DV1” to “ON” and changes the selection information associated with the device name “DV2” to “OFF”. In the case where information related to the device name “DV1” is shown on the notification screen SC18, the user is highly likely to use the MFP 10A having the device name “DV1” thereafter. Thus, changing the selection information such that the MFP 10A can be selected as a destination of instruction information improves the user convenience.

As shown by Case A in FIG. 9, in the case where the first notification related information includes the format information “Normal Banner”, the notification condition is satisfied, and the predetermined period has elapsed from the last time the information screen SC8 was displayed on the display unit 114, the terminal device 100 displays the information screen SC8 on the display unit 114 before displaying the banner-format notification screen SC14 on the display unit 114. Further, in the case where the second notification related information includes the format information “Large Screen”, the notification condition is satisfied, and the predetermined period has elapsed from the last time the information screen SC8 was displayed on the display unit 114, the terminal device 100 displays the information screen SC8 on the display unit 114 before displaying the large-screen-format notification screen on the display unit 114. In this configuration, the terminal device 100 prioritizes display of the information screen SC8 on the display unit 114 over display of the notification screens. This is because the information screen SC8 is probably more useful to the user than the notification screens. Thus, the user convenience is improved.

As shown by Case A in FIG. 9, the title in the banner-format notification screen SC14 includes a model name. The title 540 in the large-screen-format notification screen SC18 shown in FIG. 10 also includes a model name. This allows the user to know the model names targeted by the notification screens.

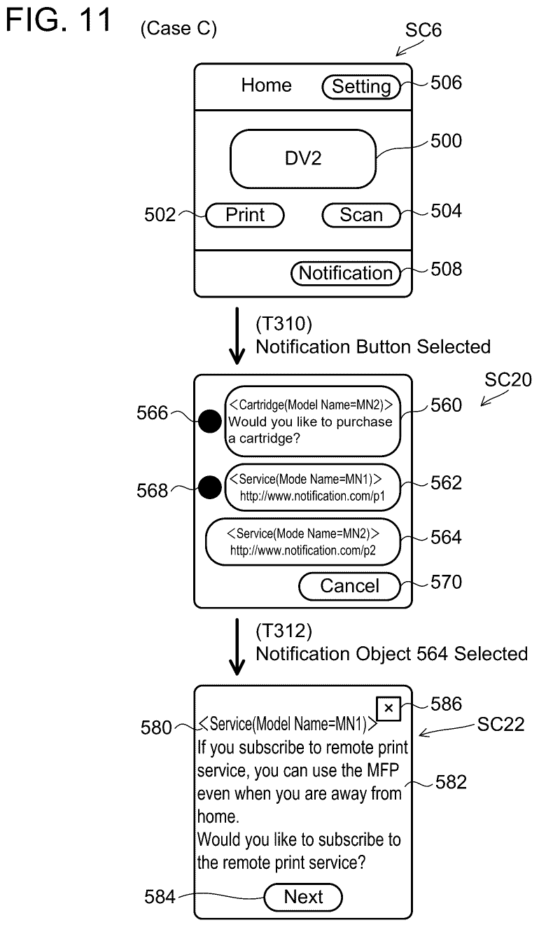

### Case C: FIG. 11

Referring to FIG. 11, Case C is described. In the initial state of Case C, the state of the device table 144 is the same as that of the device table 144 in the initial state of Case A. In the display history table 154, a display date “2023 Nov. 30” and a display number “2” are stored in association with each other. In the first notification information table 146, the operation flag “ON” is stored in association with each of the first notification related information and the second notification related information. In the second notification information table 240 in the notification server 200, third notification related information including a notification ID “ID3”, the format information “Large Screen”, title information NT3, a URL 3, button information BT3, and the dynamic display flag “OFF” is stored. The date on which Case C occurs is “2023 Dec. 3”.

First, the user performs the app activation operation to the terminal device 100. In response, as with Case B, the app 142 displays the home screen SC6 on the display unit 114 without displaying the information screen SC8 on the display unit 114.

Then, the app 142 sends a notification related information request to the notification server 200 (S52), receives the third notification related information from the notification server 200 (S54), and stores the third notification related information in association with the operation flag “OFF” in the first notification information table 146 (S56). The app 142 then executes the sequence from S90 to S94 in FIG. 7. In Case C, no notification related information is added to the notification list 148. Thus, the app 142 determines that the notification list 148 is blank (YES in S100) and does not display any notification screens over the home screen SC6.

In T310, the user performs an operation to the notification button 508 in the home screen SC6. In response, the app 142 displays a list screen SC20 on the display unit 114. The list screen SC20 includes notification objects 560, 562, 564, operation information 566, 568, and a cancel button 570. The notification objects 560, 562, and 564 correspond to the first notification related information, the second notification related information, and the third notification related information, respectively. The notification object 560 includes the title information NT1 and the message information MS1. The notification object 562 includes the title information NT2 and the URL 2. The notification object 564 includes the title information NT3 and the URL 3. The notification objects 560, 562, 564 each includes a model name. This allows the user to know the model names targeted by the notification screen. The operation information 566, 568 each indicate that user's operation to the corresponding notification screen has been already received.

In T312, the user performs an operation to the notification object 564 in the list screen SC20. In response, the app 142 sends the notification server 200 a screen data request including the URL 3 in the third notification related information as a destination and receives screen data corresponding to the URL 3. The app 142 then displays a large-screen-format notification screen SC22 on the display unit 114 by using the title information NT3 and the button information BT3 included in the third notification related information and the received screen data. The large-screen-format notification screen SC22 is displayed over the list screen SC20 covering almost the entirety of the list screen SC20. In Case C, the large-screen-format notification screen SC22 includes a title 580, a message 582, a next button 584, and a close button 586. In an example, the title 580 indicates “Service (Model MN2)”. In an example, the message 582 says “If you subscribe to the remote print service, you can use the MFP even when you are away from home. Would you like to subscribe to the remote print service?”. The character string “Next” shown on the next button 584 is information indicated by the button information BT3.

Further, the app 142 sends second operation information including the notification ID “ID3” in the third notification related information to the management server 400 and changes the operation flag associated with the third notification related information to “OFF” in the device table 144. That is, in the case where the notification related information includes the format information “Large Screen” and an operation is performed to a notification object in the list screen, the app 142 sends the management server 400 the second operation information including the notification ID included in the notification related information corresponding to the notification object and changes the operation flag to “OFF” even without an operation to a predetermined object (e.g., the next button) in the large-screen-format notification screen. The app 142 also sends operation information including a notification ID to the management server 400 when the notification object 560 or 562 is selected. In the case where the operation flag corresponding to a notification object to which the user performed an operation indicates “OFF”, the app 142 changes the operation flag to “ON”.

### Advantageous Effects of Embodiment

According to the configuration above, in the case where the terminal device 100 receives notification related information including the format information “Normal Banner” from the notification server 200, the terminal device 100 displays the notification screen SC14 according to banner format on the display unit 114. In the case where the terminal device 100 receives notification related information including the format information “Large Screen” from the notification server 200, the terminal device 100 displays the notification screen SC18 according to large-screen format on the display unit 114. Thus, depending on the notification related information received from the notification server 200, the terminal device 100 can appropriately switch the display formats for notification screens. Therefore, the user convenience is improved.

### Correspondence Relationships

The notification server 200 is an example of “first server”. The MFPs 10A, 10B are examples of “target device”. The title and message shown in a notification screen are an example of “notification information”. The title information, message information, and URLs are examples of “related information”. The banner format, the format information “Normal Banner”, and the banner-format notification screen SC14 shown in FIG. 9 are examples of “first display format”, “first format information”, and “first notification screen”, respectively. The large-screen format, the format information “Large Screen”, and the large-screen-format notification screen SC18 shown in FIG. 10 are examples of “second display format”, “second format information”, and “second notification screen”, respectively. The home screen SC6 is an example of “function selection screen”. The operation to the banner-format notification screen SC14 itself is an example of “first predetermined operation”. The management server 400 is an example of “second server”. The next button 544 in the large-screen-format notification screen SC18 shown in FIG. 10 is an example of “predetermined object”. The operation to the next button 544 in the large-screen-format notification screen SC18 shown in FIG. 10 is an example of “second predetermined operation”. The device names are examples of “device identification information”. The selection information, the selection information “ON”, and the selection information “OFF” are examples of “setting value”, “first value”, and “second value”, respectively. The MFP 10B and the device name “DV2” are examples f “first target device” and “first device identification information”, respectively. The MFP 10A and the device name “DV1” are examples of “second target device” and “second device identification information”, respectively. The subscription service registration screen SC16 shown in FIGS. 9 and 10 is an example of “first predetermined screen”. The notification condition in the first notification related information is an example of “first predetermined condition”. The information screen SC8 shown in FIG. 5 is an example of “second predetermined screen”. The notification condition in the second notification related information is an example of “second predetermined condition”. The plurality of objects 560, 562, 564 in FIG. 11 is an example of “a plurality of display areas”.

S54 in FIG. 6 is an example of “receive, from a first server, notification related information”. S114 in FIG. 7 is an example of “display on a display of the terminal device a first notification screen”. S134 in FIG. 7 is an example of “display on the display a second notification screen”.

(Modification 1) A large-screen-format notification screen, a fixed-banner-format notification screen, or a fixed-type notification screen may be an example of “first notification screen”, and a normal-banner-format notification screen, a fixed-banner notification screen, or a fixed-type notification screen may be an example of “second notification screen”.

(Modification 2) While the large-screen-format notification screen SC18 is being displayed, a user's operation to the home screen SC6 may not be disabled.

(Modification 3) The app 142 may not send operation information to the management server 400. In this modification, T130 in FIGS. 9 and T220 in FIG. 10 may be omitted. In this modification, “send first operation information to a second server” and “send second operation information to the second server” may be omitted.

(Modification 4) The app 142 may not change selection information in the device table 144 when an operation to a notification screen is received. In this modification, “change the setting value associated with the first device identification information from the first value to the second value and change the setting value associated with the second device identification information from the second value to the first value” and “change the setting value associated with the first device identification information from the first value to the second value and change the setting value associated with the second device identification information from the second value to the first value” may be omitted.

(Modification 5) The information screen SC8 may not be a prohibition screen. In this modification, the app 142 displays a normal-banner-format notification screen and a large-screen-format notification screen on the display unit 114 even while the information screen SC8 is being displayed on the display unit 114. In this modification, “in a case where the notification related information includes the first format information, the first predetermined condition is satisfied, and the predetermined period has elapsed from when the second predetermined screen was displayed on the display, display the second predetermined screen on the display before displaying the first notification screen on the display” and “in a case where the notification related information includes the second format information, the second predetermined condition is satisfied, and the predetermined period has elapsed from when the second predetermined screen was displayed on the display, display the second predetermined screen on the display before displaying the second notification screen on the display” may be omitted.

(Modification 6) The message shown in the fixed-type notification screen SC12 in FIG. 8 may indicate that the notification server 200 is down. In this modification, the state of the notification server 200 being down is an example of “state of the first server”.

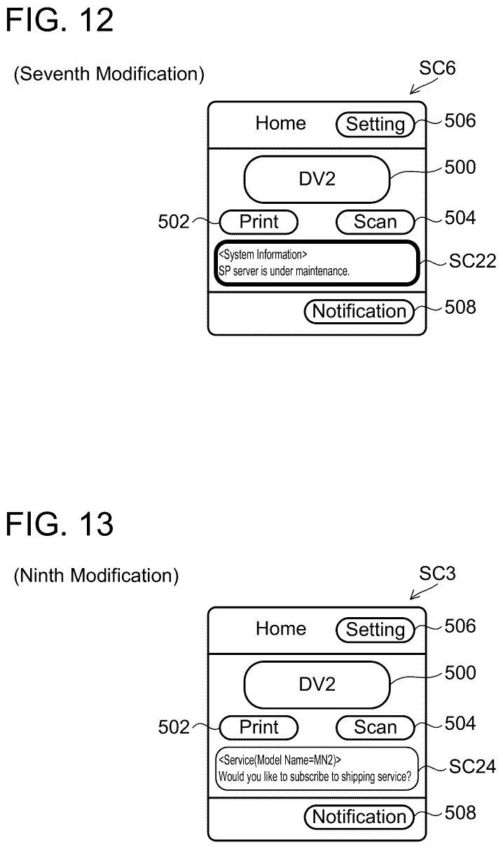

(Modification 7) As shown in FIG. 12, the message shown in the fixed-type notification screen SC22 may indicate that the SP server 300 is under maintenance. In this modification, the state of the SP server 300 being under maintenance is an example of “state of the second server”. In another modification, the message shown in the fixed-type notification screen SC22 may indicate that the SP server 300 is down. In this modification, the state of the SP server 300 being down is an example of “state of the second server”.

(Modification 8) The title information, message information, and screen data corresponding to URLs may not include any model names. In this modification, the notification objects 560, 562, 564 in the list screen SC20 shown in FIG. 11 do not include any model names.

(Modification 9) The SP server 300 may provide a shipping service for consumables (e.g., ink cartridges) used in the MFPs 10. In this modification, a notification screen may notify the shipping service. For example, as shown in FIG. 13, a normal-banner-format notification screen SC24 includes a message related to the shipping service. In an example, the message related to the shipping service says “Would you like to subscribe to the shipping service?”. When the user performs an operation to the normal-banner-format notification screen SC24 itself, a screen for subscription to the shipping service is displayed on the display unit 114.

(Modification 10) The notification server 200 and the SP server 300 may be implemented as a single server. In this modification, “first server” and “second server” are the same server.

(Modification 11) The “target device” is not limited to an MFP, and may be a printer only comprising a print engine among the print engine and a scan engine.

(Modification 12) In the embodiment above, the processes shown in FIGS. 4 to 13 are implemented by software (e.g., the programs 140, 142), however, at least one of these processes may be implemented by hardware such as a logic circuit, etc.

What is claimed is:

1. A non-transitory computer-readable recording medium storing computer-readable instructions for a terminal device comprising a processor,
wherein the computer-readable instructions, when executed by the processor, cause the terminal device to:
receive, from a first server, notification related information including format information indicating an information display format and related information related to notification information for a target device communicable with the terminal device;
in a case where the notification related information includes first format information indicating a first display format, display on a display of the terminal device a first notification screen according to the first display format, wherein the first notification screen includes first notification information related to first related information included in the notification related information; and
in a case where the notification related information includes second format information indicating a second display format different from the first display format, display on the display a second notification screen according to the second display format, wherein the second notification screen includes second notification information related to second related information included in the notification related information.

2. The non-transitory computer-readable recording medium according to claim 1, wherein a screen size of the second notification screen is larger than a screen size of the first notification screen.

3. The non-transitory computer-readable recording medium according to claim 2, wherein the first notification screen is a banner-format screen.

4. The non-transitory computer-readable recording medium according to claim 2, wherein in the case where the notification related information includes the first format information, a function selection screen for selecting a function to be executed by the target device is displayed on the display and the first notification screen is displayed over the function selection screen, and
in the case where the notification related information includes the second format information, the function selection screen is displayed on the display and the second notification screen is displayed over the function selection screen,
wherein under a state where the first notification screen is displayed over the function selection screen, an operation to the function selection screen by a user is enabled, and
under a state where the second notification screen is displayed over the function selection screen, an operation to the function selection screen by the user is disabled.

5. The non-transitory computer-readable recording medium according to claim 2, wherein the computer-readable instructions, when executed by the processor, further cause the terminal device to:
in response to a first predetermined operation to the first notification screen itself being received from a user under a state where the first notification screen is displayed on the display, send first operation information to a second server; and
in a case where a second predetermined operation to a predetermined object in the second notification screen is received from the user under a state where the second notification screen is displayed on the display, send second operation information to the second server.

6. The non-transitory computer-readable recording medium according to claim 5, wherein the computer-readable instructions, when executed by the processor, further cause the terminal device to:
store, for each of one or more target devices, device identification information for identifying the target device and a setting value indicating either a first value or a second value in association with each other in a memory of the terminal device, wherein the first value indicates that the target device is a destination of instruction information and the second value indicates that the target device is not the destination of the instruction information; and
in a case where the setting value associated with first device identification information for identifying a first target device is the first value, the setting value associated with second device identification information for identifying a second target device different from the first target device is the second value, the first notification information includes the second device identification information, and the first predetermined operation is received from the user, change the setting value associated with the first device identification information from the first value to the second value and change the setting value associated with the second device identification information from the second value to the first value.

7. The non-transitory computer-readable recording medium according to claim 5, wherein the computer-readable instructions, when executed by the processor, further cause the terminal device to:
store, for each of one or more target devices, device identification information for identifying the target device and a setting value indicating either a first value or a second value in association with each other in a memory of the terminal device, wherein the first value indicates that the target device is a destination of instruction information and the second value indicates that the target device is not the destination of the instruction information; and
in a case where the setting value associated with first device identification information for identifying a first target device is the first value, the setting value associated with second device identification information for identifying a second target device different from the first target device is the second value, the second notification information includes the second device identification information, and the second predetermined operation is received from the user, change the setting value associated with the first device identification information from the first value to the second value and change the setting value associated with the second device identification information from the second value to the first value.

8. The non-transitory computer-readable recording medium according to claim 2, wherein the computer-readable instructions, when executed by the processor, further cause the terminal device to:
in response to a first predetermined operation to the first notification screen itself being received from a user under a state where the first notification screen is displayed on the display, display a first predetermined screen on the display; and
in a case where a second predetermined operation to a predetermined object in the second notification screen is received from the user under a state where the second notification screen is displayed on the display, display the first predetermined screen on the display.

9. The non-transitory computer-readable recording medium according to claim 1, wherein the first notification screen is displayed on the display in a case where the notification related information includes the first format information, a first predetermined condition is satisfied, and a predetermined period has not elapsed from when a second predetermined screen was displayed on the display, and
the second notification screen is displayed on the display in a case where the notification related information includes the second format information, a second predetermined condition is satisfied, and the predetermined period has not elapsed from when the second predetermined screen was displayed on the display,
wherein the computer-readable instructions, when executed by the processor, further cause the terminal device to:
in a case where the notification related information includes the first format information, the first predetermined condition is satisfied, and the predetermined period has elapsed from when the second predetermined screen was displayed on the display, display the second predetermined screen on the display before displaying the first notification screen on the display, and
in a case where the notification related information includes the second format information, the second predetermined condition is satisfied, and the predetermined period has elapsed from when the second predetermined screen was displayed on the display, display the second predetermined screen on the display before displaying the second notification screen on the display.

10. The non-transitory computer-readable recording medium according to claim 1, wherein the notification information includes information related to a state of the first server.

11. The non-transitory computer-readable recording medium according to claim 1, wherein the notification information includes information related to a state of a third server that communicates with the target device.

12. The non-transitory computer-readable recording medium according to claim 1, wherein the notification information includes device identification information for identifying the target device.

13. The non-transitory computer-readable recording medium according to claim 12, wherein the computer-readable instructions, when executed by the processor, further cause the terminal device to:
in a case where a third predetermined operation is received from a user after a plurality of the notification related information is received from the first server, display on the display a list screen including a plurality of display areas corresponding to the plurality of notification related information, wherein each of the plurality of display areas includes the device identification information.

14. The non-transitory computer-readable recording medium according to claim 1, wherein the notification information includes information related to a subscription service for the target device.

15. The non-transitory computer-readable recording medium according to claim 1, wherein the notification information includes information related to a consumable article shipping service for the target device.

16. A terminal device comprising:
a display; and
a controller configured to:
receive, from a first server, notification related information including format information indicating an information display format and related information related to notification information for a target device communicable with the terminal device;
in a case where the notification related information includes first format information indicating a first display format, display on the display a first notification screen according to the first display format, wherein the first notification screen includes first notification information related to first related information included in the notification related information; and
in a case where the notification related information includes second format information indicating a second display format different from the first display format, display on the display a second notification screen according to the second display format, wherein the second notification screen includes second notification information related to second related information included in the notification related information.

17. A method for controlling a terminal device, the method comprising:
receiving, from a first server, notification related information including format information indicating an information display format and related information related to notification information for a target device communicable with the terminal device;
in a case where the notification related information includes first format information indicating a first display format, displaying on a display of the terminal device a first notification screen according to the first display format, wherein the first notification screen includes first notification information related to first related information included in the notification related information; and
in a case where the notification related information includes second format information indicating a second display format different from the first display format, displaying on the display a second notification screen according to the second display format, wherein the second notification screen includes second notification information related to second related information included in the notification related information.

18. The method according to claim 17, wherein a screen size of the second notification screen is larger than a screen size of the first notification screen.

19. The method according to claim 18, wherein the first notification screen is a banner-format screen.

20. The method according to claim 18, wherein in the case where the notification related information includes the first format information, a function selection screen for selecting a function to be executed by the target device is displayed on the display and the first notification screen is displayed over the function selection screen, and
in the case where the notification related information includes the second format information, the function selection screen is displayed on the display and the second notification screen is displayed over the function selection screen,
wherein under a state where the first notification screen is displayed over the function selection screen, an operation to the function selection screen by a user is enabled, and
under a state where the second notification screen is displayed over the function selection screen, an operation to the function selection screen by the user is disabled.
